(19) United States
(12) Patent Application Publication
(10) Pub. No.: US 2024/0164376 A1
(43) Pub. Date: May 23, 2024

(54) SYNERGISTIC PLANT GROWTH STIMULANT COMPOSITIONS OF POTASSIUM MONO/DI-FORMATE WITH NITROGENOUS COMPOUNDS

(71) Applicant: FERTIS INDIA PVT LTD, Hyderabad (IN)

(72) Inventors: Rahul Raju KANUMURU, Hyderabad (IN); George Kochumalayil SHAJI, Hyderabad (IN); Lakshmi Prasanna Kumar GARUDADRI, Hyderabad (IN); Ravikumar SURANENI, Hyderabad (IN); Sil ANINDYA, Hyderabad (IN)

(21) Appl. No.: 18/551,827

(22) PCT Filed: Mar. 30, 2022
(86) PCT No.: PCT/IN2022/050320

§ 371 Date: Sep. 21, 2023

(30) Foreign Application Priority Data
Mar. 31, 2021 (IN) 202141015392

(51) Int. Cl. A01N 37/04; A01N 37/44; A01N 47/28; A01N 59/26; A01P 21/00; C05F 11/10

(52) U.S. Cl. CPC A01N 37/04; A01N 37/44; A01N 47/28; A01N 59/26; A01P 21/00; C05F 11/10

(57) ABSTRACT

The present invention provides synergistic plant growth stimulating composition of potassium salt of organic acids with nitrogenous compounds. The composition of the present invention combats both biotic and abiotic stress, resists water logging stress, eliminates ROS thereby alleviates oxidative damages and enhances the yield and quality produce of the plants/crops.

### FIELD OF INVENTION

The present invention relates to synergistic plant growth stimulating composition of potassium salt of organic acids with nitrogenous compounds. The composition of the present invention combats both biotic and abiotic stress, resists waterlogging stress, eliminates ROS thereby alleviates oxidative damages and enhances the yield and quality produce of the plants/crops.

### BACKGROUND AND PRIOR ART

The plant growth and development as well as productivity of the crops, fruits, flowers etc. are known to be regulated by mineral components, growth hormones and small molecules that signal for expression of genes which enhance the level of plant productivity. The traditional methods of improving the plant growth include supplementing the soil or the plant with nitrogen, phosphorous, potassium (NPK) nutrients and other micro nutrients.

The present traditional methods are insufficient in the wake of growing pollution, environmental changes, rapid depletion of soil quality due to excessive use of fertilizers and other abiotic stresses such as increase level of salts in the soil, drought, cold, heat and heavy metal stresses, waterlogging stress and biotic stress on plants by living organisms specially viruses, bacteria, fungi, nematodes, insects, arachnids and weeds. These agents directly deprive their host of its nutrients can lead to death of plants. Biotic stress can become major problem because of pre- and postharvest losses.

Potassium is normally required by a growing plant to stimulate early growth, to increase protein production, and to activate beneficial enzyme and hormone systems within the plant which impact the plant's ability to withstand biotic and abiotic stress.

The typical potassium sources used are the inorganic potassium salts such as potassium chloride, potassium magnesium sulfate, potassium nitrate and potassium sulfate. The use of inorganic potassium salts, however, is found to have damaging effect on the environment.

Fertilizers are now provided with potassium derived from environmentally friendly organic potassium source.

WO2017/040938 provides fertilizer comprising soluble nitrogen, a phosphate source and a potassium source, wherein, the potassium source is an organic potassium source, animal manure, carboxylic acid salts of potassium, potassium silicate and combinations thereof. The nitrogen source is selected from the group consisting of urea, nitrate, triazone urea, ammonia, ammonium salts, ammonium hydroxide, amino acids, fish meal or extract, compost extract, kelp extract, shrimp extract, shellfish extract, and combinations thereof. The carboxylic acid salt of potassium is selected from potassium formate, potassium acetate, potassium propionate, potassium butyrate, potassium valerate, potassium hexanoate, potassium oxalate, potassium malonate, potassium succinate, potassium glutarate, potassium adipate, potassium lactate, potassium malate, potassium citrate, potassium glycolate, potassium tartrate, potassium glyoxylate, potassium pyruvate, and combinations thereof.

Plant hormones such as auxins, cytokinins, gibberellins, ethylene and abscisic acid greatly improve plant vigor, promote growth of roots and shoots and reduce stress.

EP1408761B1 discloses the use of oxytocin in combination with an adjuvant and/or carrier in the composition in order to stimulate plant growth.

U.S. Pat. No. 2,382,326A discloses a plant growth stimulant composition in dry powdered form capable of inducing rooting and stimulating healthy vigorous plant growth comprising allantoin, a plant hormone along with plant nutrient materials and plant micro metabolic elements.

EP3071534A1 discloses fertilizer compositions comprising granules of plant hormones, for example gibberellic acid-coated granules, methods of preparing such compositions, and application of such compositions to soil.

The present inventors felt that there is a scope in the art to provide an improved and effective plant growth stimulant composition capable of stimulating vigorous plant growth thereby improving the quality and yield of the crops.

### SUMMARY OF THE INVENTION

In accordance with the objective, the present invention provides plant growth stimulant composition comprising;
(i) Potassium salt of organic acids as the potassium source;
(ii) Nitrogenous compounds as nitrogen source;
(iii) Optionally growth hormones in an amount of 0.05 to 1.0 or 0.05 to 5% or 0.05 to 10% w/w;
wherein the ratio of Nitrogenous compounds to the potassium salt of organic acids varies between 1:0.5 or 1:1 or 1:2.

The potassium salt of organic acid includes but is not limited to potassium mono/diformate, potassium acetate, potassium hydrogen diacetate mixed salt of potassium with formic acid and organic carboxylic acid such as acetic acid, propionic acid, butyric acid, valeric acid, hexanoic acid, citric acid, salicylic acid and alone or combination thereof.

The Nitrogenous compounds are selected from the group such as urea and its derivatives, diacyl urea, diaryl urea, aryl urea, alkyl urea, urea formaldehyde (both oligomers and polymers), urea acrylamide compounds; amino acids like Alanine, Valine, Methionine, leucine, Isoleucine, phenylalanine, N-acetyl cysteine amide and their derivatives; or compounds such as protein and or protein hydrolysate and or peptide combination and or enzymes or compounds such as Amidates/Imidates, Amine Salts Amine Oxides-Polyamines, Azides, Aziridines and/or combination thereof in an amount of 50 to 80% of the total composition.

In an aspect, the plant growth composition of the present invention may further comprise primary nutrients like Phosphorous in an amount of 1:5 or 1:10 or 1:15 or 1:25 or 1:50 w/w of the total composition and secondary nutrients like zinc, boron, calcium, manganese, iron, copper, cobalt, magnesium, silica alone or combination thereof in an amount of 1:0.05 or 1:5 or 1:10 or 1:15 or 1:25 w/w of the total composition.

In another aspect, the composition of the present invention may comprise the plant growth hormones/plant growth regulator selected from the group consisting of auxin, cytokinin, gibberellic acid, melatonin, brassinosteroids, ethylene, abscisic acid, salicylic acid and jasmonic acid and the like alone or combination thereof in the range of 0.05 to 10% w/w.

The plant growth stimulating composition of the present invention comprises the adjuvants and or surfactants selected from anionic and Non-ionic and Cationic surfactants such as CMC, Lignosulfonates and the like alone or combination thereof in an amount ranging from 2% to 4% w/w to ensure uniform and wide spreading of the composition on the plant when applied to give complete application of foliage by maintaining surface tension of leaf and molecule contact to the plant.

In an aspect, the plant growth stimulant composition may additionally comprise agriculturally acceptable excipients, nutrients and supplements.

In another aspect, the present invention provides a process for formulating said plant growth stimulant composition comprising the potassium salt of organic acids in combination with nitrogenous compounds optionally with plant growth hormones/plant growth regulators known in the art.

In yet another aspect, the present invention provides a method to stimulate the growth in plants comprising applying an effective plant growth stimulating composition to the areas where plants are growing.

### DESCRIPTION OF THE DRAWINGS

FIG. 1: Depicts the protein content in paddy grains

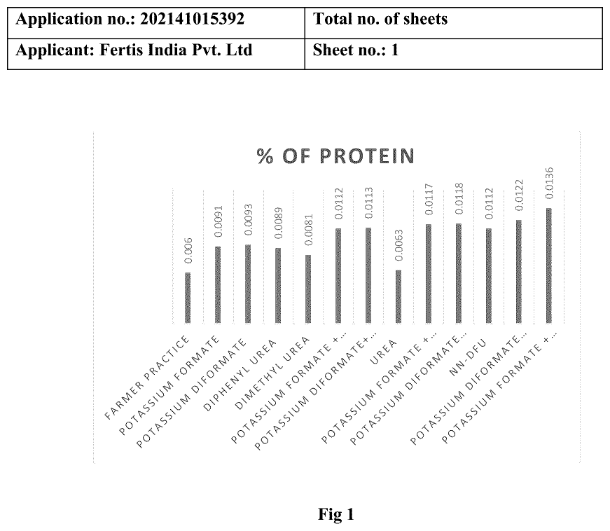

FIG. 2: Depicts the Micronutrient absorption in paddy grains

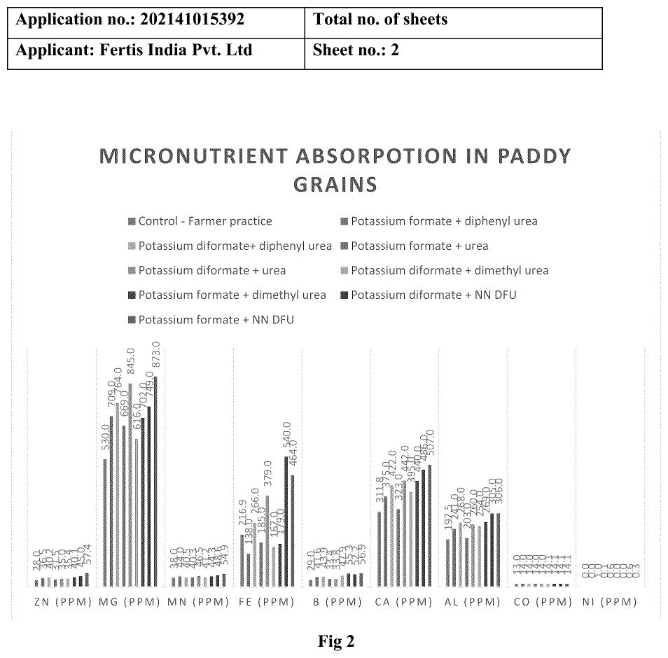

### DETAILED DESCRIPTION OF THE INVENTION

The present invention will now be will now be explained in detail with reference to its various preferred as well as optional embodiment, which, however should not be construed to limit the scope of the invention.

In an embodiment, the present invention relates to an improved plant growth stimulant composition comprising;
(i) Potassium salt of organic acids as the potassium source;
(ii) Nitrogenous compounds as nitrogen source;
(iv) Optionally growth hormones in an amount of 0.05 to 1.0% or 0.05 to 5% or 0.05 to 10% w/w;
   wherein the ratio of Nitrogenous compounds to the potassium salt of organic acids varies between 1:0.5 to 1:1 or 1:2.

The potassium salt of organic acid includes but is not limited to potassium mono/diformate, potassium acetate, mixed salt of Potassium with formic acid and organic carboxylic acid such as acetic acid, propionic acid, butyric acid, valeric acid, hexanoic acid and such like, potassium hydrogen di-salt of organic acids such as potassium hydrogen diacetate, alone or combination thereof.

The nitrogenous compounds are selected from the group such as urea and its derivatives, diacyl urea, diaryl urea, aryl urea, alkyl urea, urea formaldehyde (both oligomers and polymers), urea acrylamide compounds; amino acids like alanine, valine, methionine, leucine, Iso leucine, phenylalanine, N-acetyl cysteine amide and their derivatives; or compounds such as protein and or protein hydrolysate and or peptide combination and or enzymes or compounds such as amidates/imidates, amine salts, amine Oxides-polyamines, azides, aziridines and/or combination thereof in an amount of 50 to 80% of the total composition.

In an embodiment, the plant growth composition of the present invention may further comprise primary nutrients like Phosphorous in an amount of 1:5 or 1:10 or 1; 15 or 1:20 or 1:30 or 1:40 or 1:50 w/w of the total composition and secondary nutrients like zinc, boron, calcium, manganese, iron, copper, cobalt, magnesium, silica alone or combination thereof in an amount of 1:0.05 or 1:0.5 or 1:1 or 1:5 or 1:10 or 1:15 or 1:20 or 1:25 w/w of the total composition.

The composition of the present composition delivers 1 to 25% of potassium depending upon the source used.

The nitrogen source in the present composition delivers 1:0.05 or 1:0.5 or 1:1 or 1:5 or 1:10 or 1:15 or 1:20 or 1:25 w/w of nitrogen in the final composition.

In another aspect, the composition of the present invention may comprise the plant growth hormones/plant growth regulator selected from the group consisting of auxin, cytokinin, gibberellic acid, melatonin, brassinosteroids, ethylene, abscisic acid, salicylic acid and jasmonic acid and the like alone or combination thereof in the range of 0.05% to 10% w/w.

The plant growth stimulating composition of the present invention may further comprise adjuvants and or surfactants selected from anionic and Non-ionic and Cationic surfactants such as CMC, Lignosulfonates, and the like alone or combination thereof in an amount ranging from 2% to 4% w/w to ensure uniform and wide spreading of the composition on the plant when applied to give complete application of foliage by maintaining surface tension of leaf and molecule contact to the plant.

In an embodiment, the plant growth stimulant composition may additionally comprise agriculturally acceptable excipients, nutrients and supplements.

In yet another embodiment, the present invention relates to the process for formulating said plant growth stimulating composition thereof known in the art.

In an embodiment, the plant growth composition of the present invention is applied/delivered to the plants/crops in an amount of 0.3 kg to 1 kg/acre.

In another embodiment, the plants/crops are selected from the group consisting of paddy grains, cucurbit vegetables, peppers, potatoes, carrots, radishes, grapes, cole crops, leafy vegetables, tomatoes and the like.

The composition of the present invention may be formulated as solid in the form of tablets, powders, granules, pellets or in liquid form or in spray forms using suitable excipients/vehicles. The proportion of the various substances in the composition may vary to give specific characteristics of antioxidant and nutritional property along with abiotic and biotic stress controlling capacity.

In an embodiment, the present invention provides a method to improve plant growth (Vegetative and flowering/reproductive stage) and quality produce with stress tolerance comprising applying an effective plant growth stimulating composition comprising the potassium salt of organic acids with nitrogenous compounds optionally in combination with plant growth hormones/plant growth regulators to the plant parts or to the areas where plants are growing.

In an embodiment, the synergistic plant growth stimulating composition of the present invention combats both biotic and abiotic stress, eliminates Reactive oxygen species (ROS) thereby alleviates oxidative damages and enhances the yield and quality produce of the crops.

The enhanced protein content depicted in Figure land table 1 on application/delivery of the present composition to the plant/crops shows the increased stress tolerance of the plant. The present composition is thus effective in combating the biotic-abiotic stress which helps in improving the yield and quality produce of the plants/crops.

The following examples are illustrative of the composition embodying the present invention for use as plant growth stimulators.

### Example 1

Potassium Mono/Di -Formate with Nitrogen compounds

| Sr | | Gm in Qty/ | Gm in Qty/ | Gm in Qty/ |
|---|---|---|---|---|
| No | Component name | acre | acre | acre |
| 1 | Potassium formate or | 200 | 200 | 200 |
| | potassium diformate | | | |
| 2 | Urea | 200 | 100 | 400 |
| 3 | Diacetyl/Diacetyl/Urea | 50 | 25 | 100 |
| 4 | Diaryluea | 50 | 25 | 100 |
| 5 | Aryl Urea | 50 | 25 | 100 |
| | Total weight in gm | 550 | 375 | 900 |

### Example 2

Potassium Mono/Di -Formate with
Nitrogen compounds and hormones

| Sr | | Gm in Qty/ | Gm in Qty/ | Gm in Qty/ |
|---|---|---|---|---|
| No | Component name | acre | acre | acre |
| 1 | Potassium formate or | 200 | 200 | 200 |
| | potassium diformate | | | |
| 2 | Urea | 200 | 100 | 400 |
| 3 | Diacetyl/Diacetyl/Urea | 50 | 25 | 100 |
| 4 | Diarylurea | 50 | 25 | 100 |
| 5 | Aryl urea | 50 | 25 | 100 |
| 6 | Gibberellic acid | 2 | 1 | 4 |
| 7 | Melatonin | 2.25 | 1.125 | 4.5 |
| 8 | Abscisic acid | 1 | 0.5 | 2 |
| 9 | Adjuvants such as ligno | 10 | 5 | 20 |
| | sulfonic acids, Carboxy | | | |
| | methyl cellulose | | | |
| | Total weight in gm | 565.25 | 382.625 | 930.5 |

### Example 3

Potassium Mono/Di -Formate with Nitrogen
compounds and Antioxidants

| Sr | | Gm in Qty/ | Gm in Qty/ | Gm in Qty/ |
|---|---|---|---|---|
| No | Component name | acre | acre | acre |
| 1 | Potassium formate or | 200 | 200 | 200 |
| | potassium diformate | | | |
| 2 | Urea | 200 | 100 | 400 |
| 3 | Diacetyl/Diacetyl/Urea | 50 | 25 | 100 |
| 4 | Diarylurea | 50 | 25 | 100 |
| 5 | Aryl urea | 50 | 25 | 100 |
| 6 | Gibberellic acid | 2 | 1 | 4 |
| 7 | Melatonin | 2.25 | 1.125 | 4.5 |
| 8 | Sodium Nitroprusside | 10 | 5 | 20 |
| 9 | Adjuvants such as ligno | 10 | 5 | 20 |
| | sulfonic acids, Carboxy | | | |
| | methyl cellulose. | | | |
| | Total weight in gm | 565.25 | 382.625 | 930.5 |

### Example 4: Protein Content in the Paddy Grains

TABLE 1

| S No | Sample name | % Of Protein |
|---|---|---|
| 1 | Farmer Practice | 0.006 |
| 2 | Potassium formate | 0.0091 |
| 3 | Potassium diformate | 0.0093 |
| 4 | Diphenyl urea | 0.0089 |
| 5 | Dimethyl urea | 0.0081 |
| 6 | Potassium formate + diphenyl urea | 0.0112 |
| 7 | Potassium diformate + diphenyl urea | 0.0113 |
| 8 | Urea | 0.0063 |
| 9 | Potassium formate + urea | 0.0117 |
| 10 | Potassium diformate + urea | 0.0118 |
| 11 | N,Ndiformyl urea (NN-DFU) | 0.0112 |
| 12 | Potassium diformate + NN DFU | 0.0122 |
| 13 | Potassium formate + NN DFU | 0.0136 |

Results: Potassium diformate + NN DFU (N,N Di formyl urea) and Potassium formate with N,N Di formyl urea combination given highest protein in paddy grains samples compared with farmer practice.

### Example 5: Micronutrient Absorption in Paddy Grains

TABLE 2

| | Zn | Mg | Mn | Fe | B | Ca | Al | Co | Ni |
|---|---|---|---|---|---|---|---|---|---|
| Sample name | (ppm) | (ppm) | (ppm) | (ppm) | (ppm) | (ppm) | (ppm) | (ppm) | (ppm) |
| Control—Farmer | 28.0 | 530.0 | 38.0 | 116.9 | 29.0 | 311.8 | 197.5 | 13.0 | 0.0 |
| practice | | | | | | | | | |
| Potassium formate + | 36.5 | 709.0 | 44.0 | 238.0 | 41.6 | 375.0 | 241.0 | 14.0 | 0.0 |
| diphenyl urea | | | | | | | | | |
| Potassium diformate+ | 40.2 | 764.0 | 40.5 | 266.0 | 43.9 | 422.0 | 268.0 | 14.0 | 1.0 |
| diphenyl urea | | | | | | | | | |
| Potassium formate + | 31.5 | 669.0 | 40.3 | 185.0 | 33.4 | 323.0 | 203.0 | 14.0 | 0.1 |
| urea | | | | | | | | | |
| Potassium diformate + | 35.0 | 845.0 | 46.5 | 379.0 | 33.8 | 442.0 | 260.0 | 14.0 | 0.6 |
| urea | | | | | | | | | |
| Potassium diformate + | 35.4 | 616.0 | 41.2 | 167.0 | 47.9 | 395.0 | 254.0 | 14.1 | 0.0 |
| dimethyl urea | | | | | | | | | |
| Potassium formate + | 40.1 | 702.0 | 44.3 | 179.0 | 55.3 | 440.0 | 269.0 | 14.1 | 0.0 |
| dimethyl urea | | | | | | | | | |
| Potassium diformate + | 45.0 | 749.0 | 48.6 | 540.0 | 52.2 | 486.0 | 305.0 | 14.1 | 0.6 |
| NNDFU | | | | | | | | | |
| Potassium formate + | 57.4 | 873.0 | 54.9 | 464.0 | 56.9 | 507.0 | 306.0 | 14.1 | 0.3 |
| NNDFU | | | | | | | | | |

Results: Potassium diformate + N,N DFU(NN Di formyl urea) and Potassium formate with N,N Di formyl urea combination given highest micronutrient absorption values in paddy grains samples compared with farmer practice.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. An improved plant growth stimulant composition comprising;
(i) one or more potassium salts of organic acids as a potassium source;
(ii) Nitrogenous compounds as a nitrogen source;
(iii) Optionally growth hormones in an amount of 0.05 to 10% w/w;
wherein the ratio of Nitrogenous compounds to the one or more potassium salts of organic acids varies between 1:0.5 to 1:1 or 1:2.

2. The improved plant growth stimulant composition as claimed in claim 1, wherein the one or more potassium salts of organic acids are selected from potassium monoformate, potassium diformate, potassium acetate, a mixed salt of potassium with formic acid and organic carboxylic acid, potassium hydrogen di-salts of organic acids, alone or combination thereof.

3. The improved plant growth stimulant composition as claimed in claim 1, wherein nitrogenous compounds comprise urea and derivatives thereof, diacyl ureas, diaryl ureas, aryl ureas, alkyl ureas, urea formaldehyde (both oligomers and polymers), urea acrylamide compounds; amino acids and derivatives thereof, proteins, protein hydrolysates, peptide combinations, enzymes, amidates, imidates, amine salts, amine Oxides-polyamines, azides, aziridines, and any combination thereof combination thereof.

4. The improved plant growth stimulant composition as claimed in claim 1, wherein the plant growth hormones are selected from the group consisting of auxin, cytokinin, gibberellic acid, melatonin, brassinosteroids, ethylene, abscisic acid, salicylic acid and jasmonic acid, alone or in any combination thereof.

5. The improved plant growth stimulant composition as claimed in claim 1, wherein the composition further comprises primary nutrients including phosphorous in an amount of 1:5 or 1:10 or 1; 15 or 1:20 or 1:30 or 1:40 or 1:50 w/w of the total composition and secondary nutrients including zinc, boron, calcium, manganese, iron, copper, cobalt, magnesium, and silica alone or in any combination thereof in an amount of 1:0.05 or 1:0.5 or 1:1 or 1:5 or 1:10 or 1:15 or 1:20 or 1:25 w/w of the total composition.

6. The improved plant growth stimulant composition as claimed in claim 1, wherein the composition further comprises agriculturally acceptable excipients, N, P, K fertilizers and supplements.

7. The improved plant growth stimulant composition as claimed in claim 1, wherein, the composition is formulated as a solid or in a liquid form or in a spray form using excipients/vehicles.

8. The improved plant growth stimulant composition as claimed in claim 1, wherein, the composition improves the plant growth, enhances the yield and decrease the biotic-abiotic stress on plants.

9. A method to improve the growth in plants, enhance the yield and decrease the biotic-abiotic stress on plants comprising applying plant growth stimulant composition according to claim 1 to the areas where plants are growing.

10. The improved plant growth stimulant composition as claimed in claim 1, wherein the growth hormones in an amount of 0.05 to 5% w/w.

11. The improved plant growth stimulant composition as claimed in claim 1, wherein growth hormones in an amount of 0.05 to 1.0% w/w.

12. The improved plant growth stimulant composition as claimed in claim 2, wherein the organic carboxylic acid is acetic acid, propionic acid, butyric acid, valeric acid, or hexanoic acid.

13. The improved plant growth stimulant composition as claimed in claim 2, wherein the potassium hydrogen di-salt is potassium hydrogen diacetate.

14. The improved plant growth stimulant composition as claimed in claim 3, wherein the amino acids comprise alanine, valine, methionine, leucine, Iso leucine, phenylalanine, N-acetyl cysteine amide and derivatives thereof.
